(19) United States
(12) Patent Application Publication
(10) Pub. No.: US 2011/0040577 A1
(43) Pub. Date: Feb. 17, 2011

(54) Holistic health quarters system, product and methods

(76) Inventor: Kevin Dominic Ward, San Francisco, CA (US)

Correspondence Address: Kevin Dominic Ward, # E1210, 455 Eddy Street, San Francisco, CA, 94109, US

(21) Appl. No.: 12/661,966

(22) Filed: Mar. 26, 2010

Related U.S. Application Data
(60) Provisional application No. 61/180,688, filed on May 22, 2009.

(51) Int. Cl. G06Q 50/00; G06Q 90/00

(52) U.S. Cl. 705/3; 705/500; 705/2

(57) ABSTRACT

A system, product and method for providing holistic health quarters and more generally to a process for providing recovery services in a holistic health quarters that offers facilities to transitional housing facilities that incorporate innovative, water-based hydro therapy pools, holistic therapies for athletes, post-operative patients, and individuals looking to enhance their overall fitness to unprecedented levels of efficiency and intensity. The system, product and methods also relate generally to a means for providing hydro therapy underwater treadmill and pool, resistance therapy jets, directional jet systems for hydro massage, underwater monitoring, and adjustable water depth technology for post-operative patients and athletes looking for holistic therapies, or fitness regiments.

### CROSS-REFERENCES TO RELATED APPLICATIONS

This application claims the benefit of U.S. Provisional Application Ser. No. 61/180,688, filed May 22, 2009, the disclosure of which is incorporated herein by reference in its entirety.

### BACKGROUND

The subject matter herein relates generally to a system, product and method for providing holistic health quarters and more generally to a process for providing recovery services in a holistic health quarters that offers facilities to transitional housing facilities that incorporate innovative, water-based hydro therapy pools, holistic therapies for athletes, post-operative patients, patients continuing their addiction recovery, and individuals looking to enhance their overall fitness to unprecedented levels of efficiency and intensity. Further, the subject mater also relates generally to a means for providing hydro therapy underwater treadmill and pool, resistance therapy jets, directional jet systems for hydro massage, underwater monitoring, and adjustable water depth technology for post-operative patients and athletes looking for holistic therapies or fitness regiments. The present transitional housing services, systems and methods.

One aspect of the current invention involves post operative transitional housing for patients. Many post operative participants have significant transitional needs for services once rehabilitation services have been provided by an in-patient or out-patient team of therapists and medical health care professionals. In one aspect, addiction to alcohol or narcotic drugs is a major problem and has to be dealt with promptly and effectively. The addiction takes a toll on the addict as well as on the family of the addict and the society at large. The individual addict is the most affected. He is affected mentally, emotionally, physically, socially and spiritually as are the family and friends of the addict. In another aspect, transitional services to train from injury or post operative conditions may require specialized equipment and programs in an upscale setting to provide holistic health quarters and housing for patients with specialized needs.

In the case of mental health conditions and related addictions, many people assume that such conditions or addiction is the product of flawed character or is a part of a person's identity. This tendency to mark behaviors as aspects of a person rather than as aspects of their health condition or circumstances or situation has been termed by psychologists as the fundamental attribution error (FAE). The fact is, mental health conditions and addictions are treatable, even curable, but in order to help individuals out of these illnesses, the underlying causes of the mental health conditions and addictions must first be properly diagnosed, addressed in an in-patient or out-patient treatment program, and then treated through on-going transitional treatment.

An addict or mental health patient might lose his or her job as well as social standing, making it a difficult situation for the patient as well as for family, friends, colleagues and employers of the patient. The loss of employment could result in financial difficulties. As addiction and mental health are major societal issues, many steps have been taken to ensure treatment of an individual who suffers from these conditions.

There are many rehabilitation programs and centers as well as detoxification programs that treat various mental health patients or program participants. Once the program ends, the recovering patient returns to life in the real world but is still at risk of relapsing into addiction or other related conditions. For such purposes, ‘transitional houses’ have been established to allow recovering patients to adjust back to normal life. Such transitional housing does not provide for any continued care and treatment and is meant simply to house the recovering patients. The recovering patients have special needs as do those in recovery with disorders such as compromised immune systems or other infections. Such needs are not catered to by existing transitional facilities or services. Further, the existing transitional facilities and services fails to address more specific needs of other post operative patients nor the needs of high performance, world class athletes looking for a condition regiment or holistic therapies that allow a patient or athlete to cleanse themselves by conditioning the mind and spirit or to implement custom dietary programs utilizing holistic supplement treatments.

In one previous existing approach, US Patent application 20060229914 (Armstrong 2006) describes a method of providing support for, and monitoring of individuals with addictive behavior. A system that talks about using a remote server to link all those that join the program is described therein. However, this method does not ensure total commitment to the part of both the addict as well as the program monitor. Transitional housing on the other hand ensures constant contact with the recovering addict, leading to much better results.

By using a holistic method of rehabilitation-mixing hydro pool therapy, nutrition, exercise, psychotherapy, and other methods, it is possible to address a broad universe of patients and those in recovery requiring post operative and transitional housing services. Currently, there are no facilities or rehabilitation systems that nourish the needs of patients, those in recovery, AND athletes, yet the needs of each population have many similar characteristics.

What is therefore needed are systems, products and methods to nourish “the whole athlete” and “the whole individual” in recovery and those individual participants seeking overall body conditioning. What is needed is a system, product and methods for providing patients, those in recovery, and athletes with a resort-type upscale, holistic facility that emphasizes uniquely designed, water-based hydro pool therapy rehabilitation systems and treatment methods that allow for adjustments as water levels rise or fall and the body becomes more or less buoyant, allowing the amount of weight bearing to be adjusted. What is further needed is to provide systems, therapeutic methods, and products that result in less pain and stress on the joints than traditional land-based therapy and exercise. There are currently no unique hydro pool rehabilitation system designs that enhance water-based therapy with several high quality technology applications to produce accelerated recoveries as well as advanced strength and overall mind and body conditioning in an upscale, holistic health quarters transitional housing setting. As such, what is further needed is a new system, product and methods for providing transitional/rehabilitation homes that pair state-of-the-art water-based therapy with holistic treatments in an upscale environment.

### SUMMARY OF THE INVENTION

The present disclosure is directed to holistic health quarters systems, products and methods.

In one embodiment, a holistic health care, transitional housing system, comprises of referral of a prospective participant; an upscale health quarters facility wherein post operative, athletic training, and mental health services are provided; one or more hydro-therapy pool devices are provided wherein spa based therapies include advanced technology monitoring to produce accelerated recoveries; one or more transitional treatment programs are designed and implemented for one or more participant classifications wherein a program includes therapeutic treatment methods and holistic health care methods; one or more program participants are profiled into one or more classifications; an information management monitoring program collects and analyzes one or more program participant attributes; one or more program participant outcomes are determined from the one or more program participant outcomes wherein said program participant outcome does not result in at least one subsequent transitional housing program plan and therapeutic treatment method.

In further aspects, the system may variously include an information management monitoring program that is implemented in a computing system and an operating environment. In other various aspects, the system is provided wherein the hydrotherapy pool devices include one or more therapeutic devices selected from a group consisting of one or more hydro massage hose devices, one or more underwater monitoring systems, and one or more adjustable height pools.

In another embodiment of the invention, a holistic health care, transitional housing system is provided wherein the one or more therapeutic devices include at least one underwater camera and wherein at least one underwater camera provides real time data to the information management monitoring system.

In another embodiment, a holistic health care, transitional housing system, comprises a referral of a prospective participant; an upscale health quarters facility wherein post operative, athletic training, and mental health services are provided; one or more hydro-therapy pool devices are provided wherein spa based therapies include advanced technology monitoring to produce accelerated recoveries; one or more transitional treatment programs are designed and implemented for one or more participant classifications wherein a program includes therapeutic treatment methods and holistic health care methods; one or more transitional care specialist analyze and profile one or more participants; one or more program participants re profiled into one or more classifications; an information management monitoring program collects and analyzes one or more program participant attributes; one or more program participant outcomes are determined from the one or more program participant attributes analyzed and collected by the information monitoring program; a discharge plan is designed an implemented for one or more program participant outcomes wherein said program participant outcome does not result in at least one subsequent transitional housing program plan and therapeutic treatment method; and the system further compromises a preparation plan for post treatment healing plans for self-implementation by the program participant; a short term psychotherapy optional service program; a sports therapy optional service program; an aromatherapy optional service program; one or more certified personal trainers; one or more customized organic food plan optional services program; an acupuncture optional service program; a reflexology optional service program; a psychological profile and holistic practices discharge plan for each program participant; a reentry plan for post transition reintegration of the program participant; and one or more post-rehabilitation, post transitional reintegration support plans.

In another embodiment, a holistic health care, transitional housing system, comprises a referral of a prospective participant; an upscale health quarters facility wherein post operative, athletic training, and mental health services are provided; one or more hydro-therapy pool devices are provided wherein spa based therapies include advanced technology monitoring to produce accelerated recoveries; one or more transitional treatment programs are designed and implemented for one or more participant classifications wherein a program includes therapeutic treatment methods and holistic heath care methods; one or more transitional care specialist analyze and profile one or more participants; one or more program participants are profiled into one or more classifications; and information management monitoring program collects and analyzes one or more program participant attributes; one or more program participant attributes analyzed and collected by the information monitoring program; a discharge plan is designed and implemented for one or more program participant outcomes wherein said program participant outcome does not result in at least one subsequent transitional housing program plan and therapeutic treatment method; and the system further comprises a preparation plan for post treatment healing plans for self-implementation by the program participant; a short term psychotherapy optional service program; one or more certified personal trainers; one or more customized organic food plan optional service program; a psychological profile and holistic practices discharge plan for each program participant; a reentry plan for post transition reintegration of the program participant; and one or more post-rehabilitation, post transitional reintegration support plans; and also further comprises said upscale holistic health quarter facility including one or more private one-bedroom suites; a wireless Internet service throughout said facility; an LCD/DVD/Stereo in every suite; a personal housekeeper service 24/7 staff availability service program; one or more entertainment systems for each program participant's use; at least one sports medicine physician on-call; one or more sauna and steam rooms; a care available for program participants; a theatre; and one or more meeting rooms.

In another embodiment, a method for providing athletic, post-injury training in an upscale, holistic transitional housing facility, includes the following steps in various order: preparing athletes for a rehabilitation program, evaluating the athlete's physical condition, evaluating the athlete's mental state by conducting one or more clinical tests, implementing one or more holistic health quarters treatment plans, providing one or more hydro-pool therapy plans implemented by utilizing one or more of a group of treatment systems consisting of an underwater treadmill, resistance therapy jets, and hydro massage, wherein the one or more hydro-pool therapy plans may variously include a method for underwater monitoring and adjustable floor and depth settings.

In another embodiment, a method of providing holistic health quarters, transitional housing, comprises the following steps in any order: providing a referral of a prospective participant; providing an upscale health quarters facility wherein post operative, athletic training, and mental health services are implemented; arranging one or more hydro-therapy pool devices are provided wherein spa based therapies include advanced technology monitoring to produce accelerated recoveries; designing and implementing one or more transitional treatment programs for one or more participant classifications wherein a program includes therapeutic treatment methods and holistic health care methods; assigning one or more transitional care specialist to analyze and profile one or more participants; creating a profile for one or more program participants into one or more classifications; providing an information management monitoring program that collects and analyzes one or more program participant attributes; determining one or more program participant outcomes from the one or more program participant attributes analyzed and collected by the information monitoring program; providing a discharge plan that is designed and implemented for one or more program participant outcomes wherein said program participant outcome does not result in at least one subsequent transitional housing program plan and therapeutic treatment method. A method of providing holistic health quarters, transitional housing, comprises the following steps in any order: providing a referral of a prospective participant; providing an upscale health quarters facility wherein post operative, athletic training, and mental health services are implemented; arranging one or more hydro-therapy pool devices are provided wherein spa based therapies include advanced technology monitoring to produce accelerated recoveries; designing and implementing one or more transitional treatment programs for one or more participant classifications wherein a program includes therapeutic treatment methods and holistic health care methods; assigning one or more transitional care specialist to analyze and profile one or more participants, creating a profile for one or more program participants into one or more classifications; providing an information management monitoring program that collects and analyzes one or more program participant attributes; determining one or more program participant outcomes from the one or more program participant attributes analyzed and collected by the information monitoring program; providing a discharge plan that is designed and implemented for one or more program participant outcomes wherein said program participant outcome does not result in at least one subsequent transitional housing program plan and therapeutic treatment method; and wherein the one or more therapeutic devices are selected from a group consisting of one or more variable speed underwater treadmills, one or more resistance therapy jet pools, one or more hydro massage hose devices, one or more underwater monitoring systems, and one or more adjustable height pools.

In further aspects of the embodiment, the method is provided wherein the one or more therapeutic devices include at least one underwater camera and wherein at least one underwater camera provides real time data to the information management monitoring system. In other various aspects, the method is provided providing a preparation plan for post treatment healing plans for self-implementation by the program participant; offering a short term psychotherapy optional service program; providing a sports therapy optional service program; providing an aromatherapy optional service program; directly treating one or more program participants with one or more certified personal trainers; designing one or more customized organic food plan optional services program; providing an acupuncture optional service program; providing a reflexology optional service program; designing and providing a psychological profile and holistic practices discharge plan for each program participant; designing a reentry plan for post transition reintegration of the program participant; and creating one or more post-rehabilitation, post transitional reintegration support plans.

In another embodiment, A holistic health care, transitional housing system, comprises means for a referral of a prospective participant; means for an upscale health quarters facility wherein post operative, athletic training, and mental health services are provided; means For one or more hydro-therapy pool devices are provided wherein spa based therapies include advanced technology monitoring to produce accelerated recoveries; means for one or more transitional treatment programs are designed and implemented for one or more participant classifications wherein a program includes therapeutic treatment methods and holistic health care methods; means for one or more transitional care specialist analyze and profile one or more participants; means for one or more program participants are profiled into one or more classifications; means for providing an information management monitoring program collects and analyzes one or more program participant attributes; means for one or more program participant outcomes are determined from the one or more program participant attributes analyzed and collected by the information monitoring program; means for a discharge plan is designed and implemented for one or more program participant outcomes wherein said program participant outcome does not result in at least one subsequent transitional housing program plan and therapeutic treatment method.

In another embodiment, a computer system for providing holistic health quarter, transitional housing services, comprising a bus; a memory unit coupled with said bus; a processor coupled with said bus, said processor for executing a method for providing methods and products for holistic health quarters and transitional housing to implement the steps of: analyzing monitoring and management data comprises accessing said monitoring and management data further comprising a first group and a second group of memory stored monitoring and management data strings; partitioning a portion of said monitoring and management data into said first group of memory stored monitoring and management data strings, said partitioning into said first group based on a fixed byte-width property of said monitoring and management data strings; partitioning a portion of said monitoring and management data into said second group of memory stored monitoring and management data strings, said partitioning into said second group based on a variable byte-width property of said monitoring and management data strings; searching through said first group of monitoring and management data strings for a prescribed string utilizing a fixed byte-width monitoring and management data string process; searching through said second group of monitoring and management data strings for a prescribed string utilizing a variable byte-width monitoring and management data string process, wherein the execution of said fixed byte-width monitoring and management data string process is more efficient that the execution of said variable byte-width monitoring and management data string process to implement various steps to implement holistic quarter services that may be provided and included in various forms of computer readable media utilizing a computer implemented rehabilitation transitional housing healthcare management system; providing computer readable media to receive data from one or more external peripheral devices that are specially designed to be coupled with one or more hydro-pool therapy treatment programs and one or more upscale, holistic health post operative or athletic training plans; providing a referral of a prospective participant; providing an upscale health quarters facility wherein post operative, athletic training, and mental health services are implemented; arranging one or more hydro-therapy pool devices are provided wherein spa based therapies include advanced technology monitoring to produce accelerated recoveries; designed and implementing one or more transitional treatment programs for one or more participant classifications wherein a program includes therapeutic treatment methods and holistic health care methods; assigning one or more transitional care specialist to analyze and profile one or more participants; creating a profile for one or more program participants into one or more classifications; providing an information management monitoring program that collects and analyzes one or more program Participant attributes; determining one or more program participant outcomes from the one or more program participant attributes analyzed and collected by the information monitoring program; and providing a discharge plan that is designed and implemented for one or more program participant outcomes wherein said program participant outcome does not result in at least one subsequent transitional housing program plan and therapeutic treatment method.

Another embodiment may be configured so as to utilize the software program code to implement the steps of the therapeutic methods.

Another embodiment provides for a method of increasing form and gain function monitoring is included.

Another embodiment provides for a method of providing real time monitoring and management of hydro therapy pools utilizing underwater cameras.

The construction and method of operation of the invention, together with additional objectives and advantages thereof, will be best understood from the following description of specific embodiments when read in connection with the accompanying drawings.

### BRIEF DESCRIPTION OF THE DRAWINGS

FIG. 1 shows a holistic health housing system including a holistic health housing server including a database and holistic transitional system.

FIG. 1a shows a holistic health housing system including an information management monitoring program.

FIG. 1b shows a holistic transitional system including a holistic health server and an information management monitoring program operating environment.

FIG. 2 shows a method for providing holistic health quarters program participant outcomes.

FIG. 3 shows a flow sheet of the process of treatment and recovery process of an individual participant as an embodiment of the present invention.

FIG. 4 shows another embodiment for a method of evaluation recovery of selected participants and determining when to pronounce fully recovered.

FIG. 4b shows another embodiment for providing athletic, post-injury training.

FIG. 5 shows another embodiment of a method for testing, evaluating and providing holistic healing activities.

FIG. 6 shows another embodiment for providing a holistic health plan post rehabilitation transition plan for a program participant.

FIG. 7 illustrates program code for implementing a holistic health quarters system.

FIG. 8 illustrates program code for implementing a holistic health quarters system for providing real time data elements from at least one underwater camera.

FIG. 9 illustrates an embodiment for providing program code for partitioning monitoring and management data in a computer readable medium.

FIG. 10 illustrates a method for providing real time data elements for accessing and monitoring holistic health quarters system data.

FIG. 11 illustrates a method for providing means for providing real time data elements for accessing and monitoring holistic health quarters systems.

FIG. 12 illustrates a computer readable medium to provide program code for providing real time data elements for accessing and monitoring holistic health quarters systems.

FIG. 13 illustrates an exemplary operating environment.

FIG. 14 illustrates an exemplary computing system.

### DETAILED DESCRIPTION OF THE DRAWINGS

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

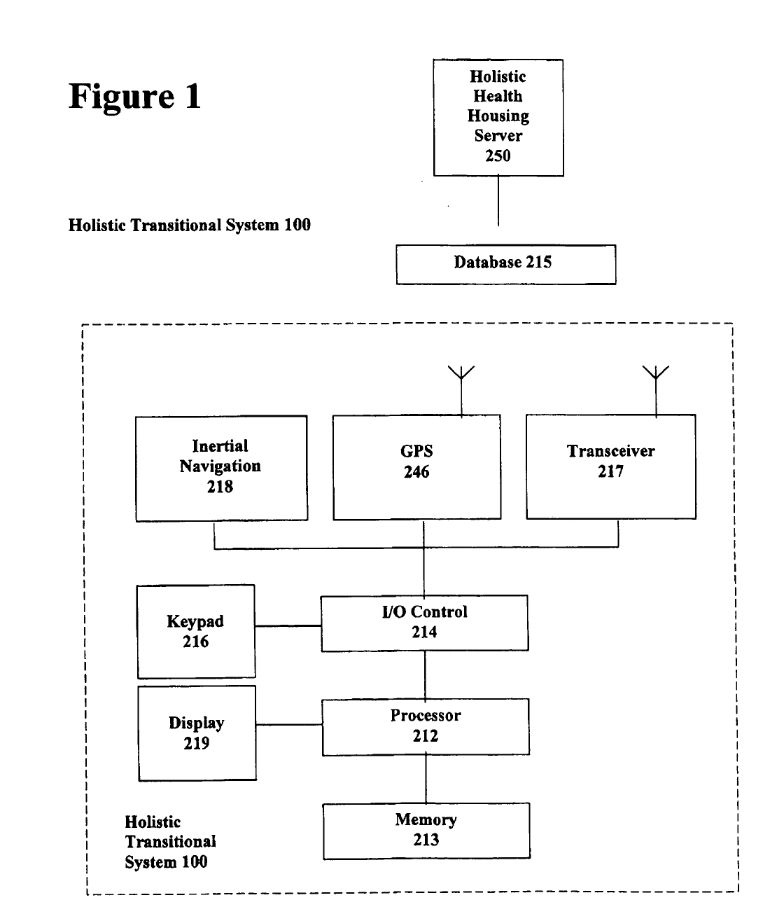

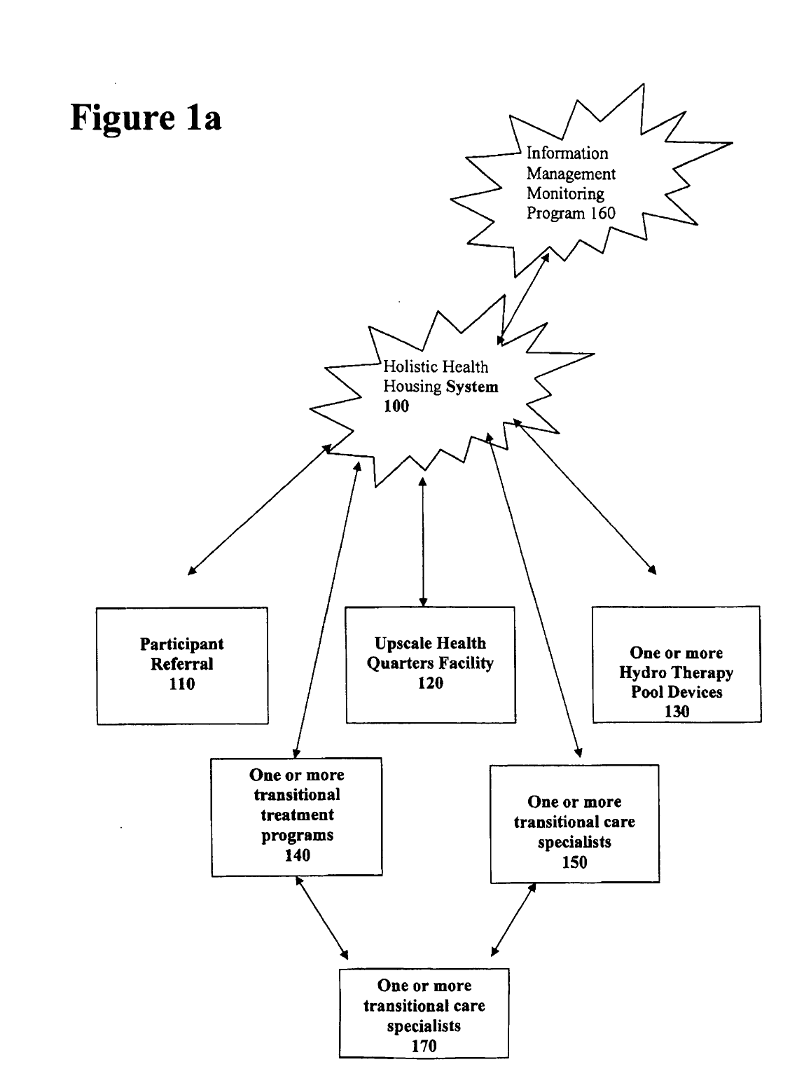

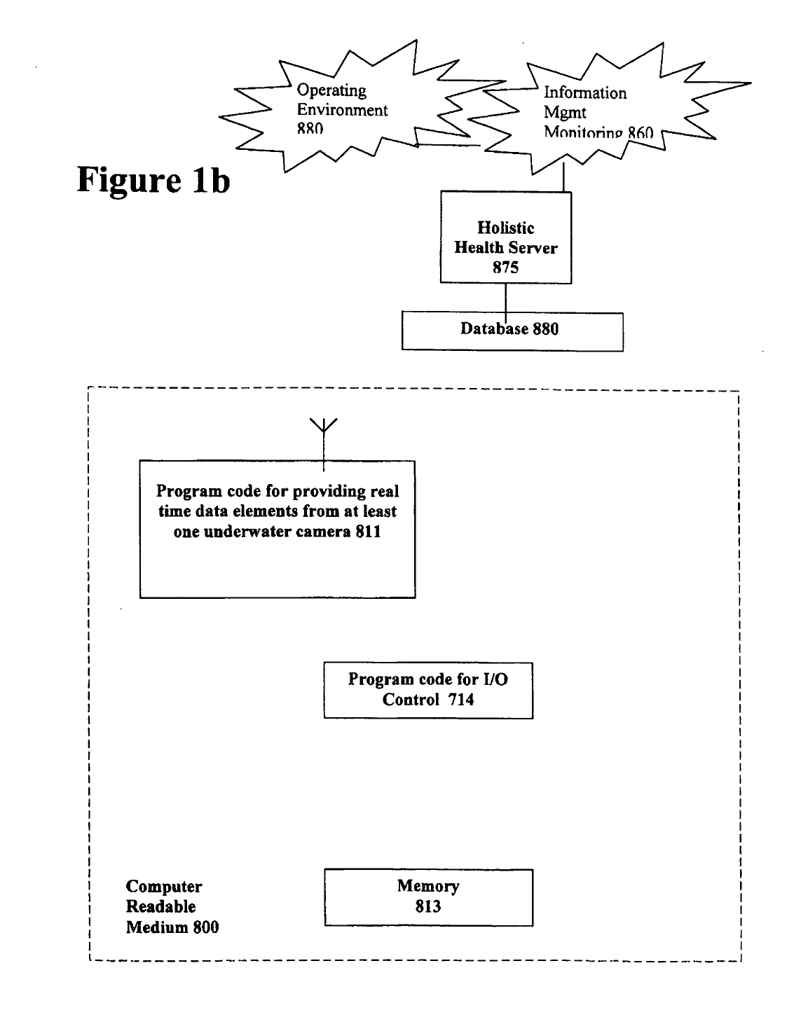

FIG. 1a illustrates a first embodiment of the present invention. The present invention relates to a system for creating a holistic health housing to implement a process for providing therapeutic treatment methods and holistic health care to persons with addiction to drugs, alcohol or other substances and who may be suffering from other conditions such as compromised or weakened immune systems. In addition, those in recovery, athletes or post operative patients may also need the holistic therapeutic methods of hydro pool, rehabilitation systems. The first overall system 100 involves an individual in recovery and admitting him or herself into the said process by a referring a patient utilizing a recommendation of either a practicing physician or a rehabilitation center or a family member or an employer or volunteers to do so himself as shown in 110 of FIG. 1. The recovering patients (hereinafter called participants) are subjected to various medical and psychological testing and one or more profiles are created for one or more program participants 110, in an upscale health quarters facility 120. The upscale holistic health housing system further includes one or more hydro therapy pool devices 130, one or more transitional treatment programs 140, one or more transitional care specialist 150, and one or more transitional care rehabilitation specialist 170. The one or more transitional care specialist 150 and one or more transitional care specialist 150 and one or more transitional care rehabilitation specialists 170 utilize a preconfigured information management monitoring program 160 to create one or more program participant outcomes, one or more program participant attributes, and at least on discharge plan designed and implemented for one or more program participant outcomes. Based on the results of the said profiling the participants are further classified on the basis of set criteria into groups based on type of addiction, medical and addiction history, and are finally profiled based on the presence or absence of any specific other diseases such as compromised or weakened immune system. The participants, once classified, are next assigned to tailor-made programs based on the said results. The tailor-made programs are comprised of a basic set of events and a special set of activities which are comprised of additional holistic healing methods selected on the basis of the said results, and other activities.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to affect such feature, structure or characteristic in connection with other embodiments whether or not explicitly described. Parts of the description are presented using terminology commonly employed by those of ordinary skill in the art to convey the substance of their work to others of ordinary skill in the art.

In another embodiment, as shown in FIG. 1b, a holistic transitional system 100 includes a holistic health server 175, database repository 180 to access and automate the information management monitoring system 160 and operating environment 180. The system may further include one or more therapeutic devices 190, at least one underwater camera 192 to provide data to send, receive and collect data for the holistic transitional system 100. The system also includes at least one input/output (I/)) control module 194, at least one processor 195, at least one memory module 193, at least one keypad 196, and at least on display device 199.

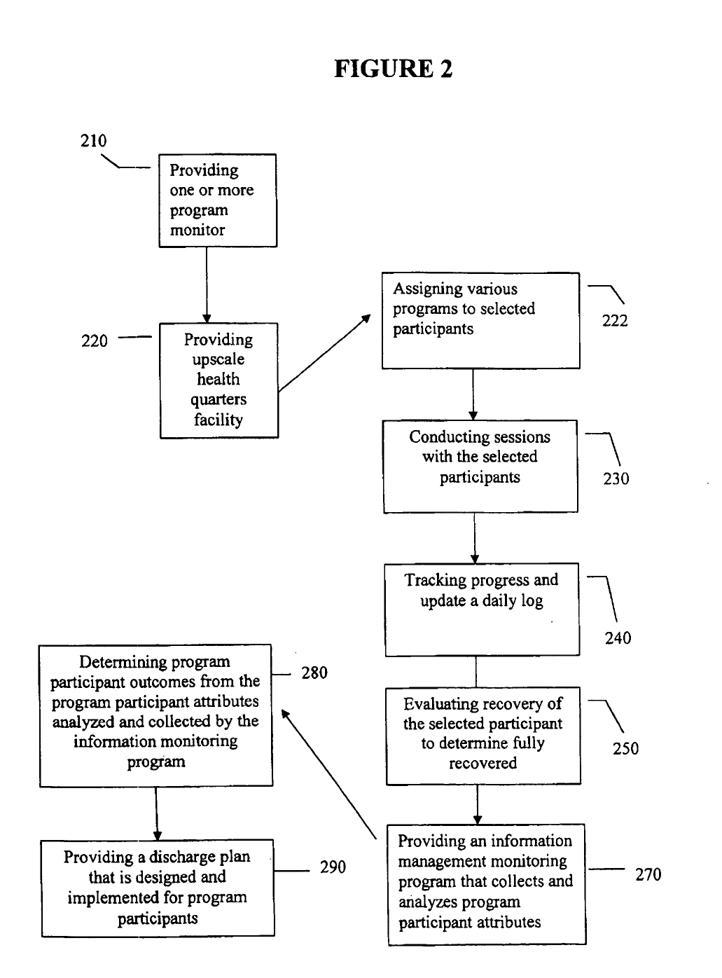

FIG. 2 shows another embodiment comprising a method for providing a program monitor 210 that is assigned to the participants to monitor their progress as illustrated in the block diagram show in FIG. 2. The program monitor 210 evaluates the results and classifies the participants in an upscale health quarters facility 220. In a next step, the program monitor then assigns various programs 222 to the selected participants 222. The program monitor 210 conducts sessions 230 with the selected participants 222 and coordinates with other professionals working with the participants assigned to the said monitor 210 to track progress 240 of the selected participants 222, and updates a daily log 240 of the participants and finally evaluates recovery of the selected participants 222 and determines whether to pronounce them as fully recovered 250. In other various aspects, the embodiment may variously include a rehabilitation healthcare professional to provide out-patient rehabilitation services at the upscale, transitional housing facility on a contract basis wherein one or more operative or athletic training program may be utilized. In other various aspects, one or more hydro therapy pools may also be included and may in some cases include underwater monitoring cameras to enhance workout and conditioning efficiency, effectiveness, and monitoring of treatment plans, physical and mental conditions.

The basic set of events in the daily log 240 comprises one or more events including fitness training with professional trainers, daily diet chart with personal chef, daily meeting with a personal program monitor, or daily meetings with other program monitor health care professionals 210. In certain aspects, the embodiment may variously include in-patient rehabilitation health care, mental health, drug and alcohol recovery, or post operative physical disabilities treatment plans and services. The overall method for providing holistic health care facility systems and methods 200 comprises a means not just for physical and mental injury rehabilitation but also for holistic healing and support activities such as Chi Gong, Acupuncture, Massage therapy, Pet therapy, Aromatherapy and many other such holistic therapies that help in complete healing of the participant's physical, mental, and in some cases, spiritual well being. The activities are assigned as per the program assigned as well as the profiling results 240 of the participants. In other various aspects, the methods may include faith based treatment plans and other community initiatives in the upscale, transitional housing facility.

FIG. 3 also shows yet another embodiment overall method for providing holistic health care facility systems and methods 300 comprises providing a means not just for physical and mental injury rehabilitation 305 but also providing a means for holistic healing and support activities 307, further providing a set of supplemental activities 308 that comprises one or more regular meetings with one or more counselors 309 as shown in FIG. 3. Regular meetings may variously include attending support group meetings, spending time with family, spa sessions, and other meetings with treatment of diagnosed physical and mental conditions. The method for providing a means for physical and mental injury rehabilitation 305 subsequently includes the steps for: providing a referral of prospective participants 310, providing upscale health quarters facility, arranging one or more hydro-therapy pool devices to produce accelerated recoveries, designing and implementing one or more transitional treatment programs, assigning transitional care specialist to analyze and profile participants, providing a profile for program participants into classifications, providing and information management monitoring program that collects and analyzes program participant attributes, determining program participant outcomes from the program participant attributes analyzed and collected by the information monitoring program, and providing a discharge plan that is designed and implemented for program participants.

In another embodiment of the present invention process as shown in FIG. 3 the participant is admitted to one or more programs upon the recommendation of a participant's family and is subjected to medical, physical fitness and psychological test 350. Following evaluation and issuing of a detailed results report 120, the participant is accordingly classified as a recovering addict, an athlete with specific post injury rehabilitation requirements, a post operative patient, or a special needs high performance athletic training participant. One or more programs may be tailored to address the unique requirements of each population a group program and an individually tailored program is then tailored for each individual participant or patient. In yet another embodiment, the participant may be classified with a compromised or weakened immune systems or other related physical conditions as a result of corresponding diagnosis from one or more mental health professional. The participant or patient is then taken scheduled and monitored for a further set of treatment methods. Based on the result 120 and classification 330, the said program monitor 310 assigns and initiates a tailor-made program 330, which includes a basic set of activities 340 such as fitness training by professional trainer, daily diet planning with personal chef, or a daily meeting with the personal program monitor 310. A special set of Holistic healing activities 350 are assigned on the basis of the results 120 and classification 330 and could include therapies such as Chi Gong therapy, Acupuncture, Pet therapy and other therapies that are beneficial to those in recovery and those with weakened or compromised immune systems. The said other activities 360 include sessions with the counselor, spa sessions, spending time with family, attending 12 step meetings etc.

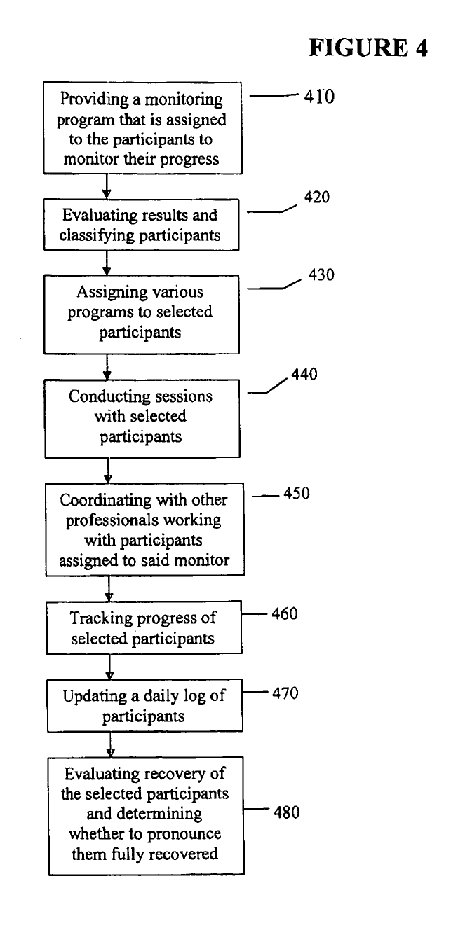

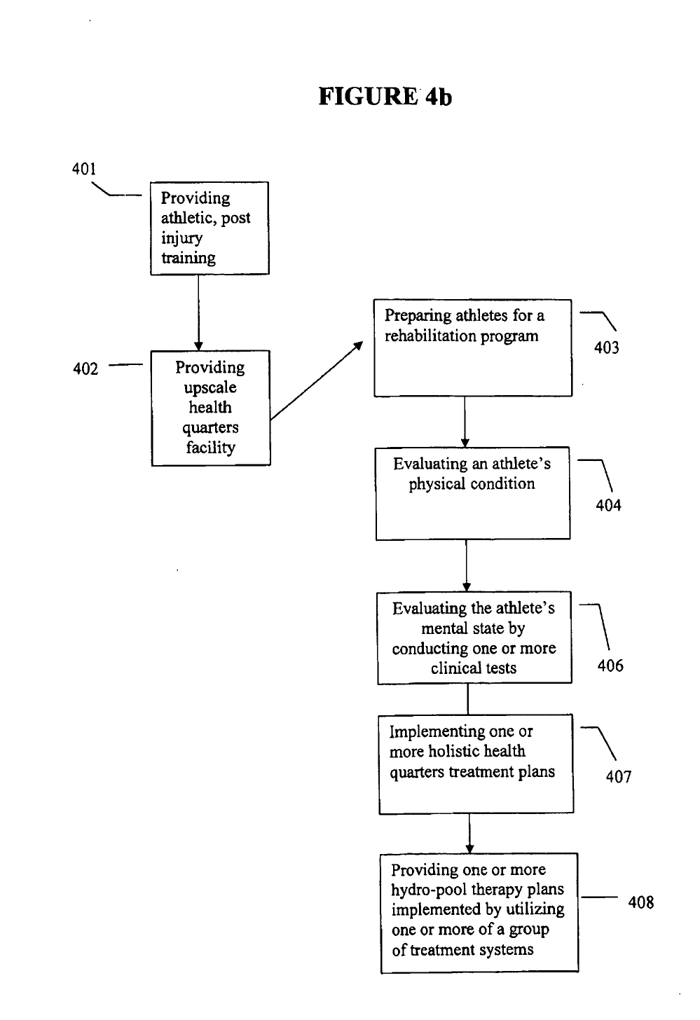

In another embodiment as shown in FIG. 4, a method for determining when to diagnose a program participant as fully recovered includes steps for: providing a monitoring program that is assigned to the participants to monitor their progress wherein the program monitor will enter the progress and daily events of the day in the daily log in an information monitoring program 415 of the participant and provide many such guidance as required by the participant and coordinate with other counselors and professionals who work with the participant, to monitor and evaluate the progress of the participant 420. The method also includes steps, not necessarily in consecutive order, for assigning various programs to selected participants 430, conducting sessions with selected participants 440, coordinating with other professionals working with participants assigned to said monitor 450, tracking progress of selected participants 460, updating a daily log of participants 470, and evaluating recovery of the selected participants and determining whether to pronounce, or diagnose, the participants as fully recovered 480. The duration of the said tailor-made program may vary from as little as 1 month to 6 months in some embodiments to a long as up to a year in other embodiments, based on the needs of the participants and the evaluation of the daily log information monitoring program 470, 480 of the participants. Based on these evaluations, the participants may have an extended period of recovery. As a further embodiment of the present invention, the participants are provided with ongoing inputs from drug recovery programs and professionals from rehabilitation centers. In other various aspects of the current embodiment, the participants will be housed in private rooms with interne facilities and entertainment centers. In other various aspects, strict confidentiality will be maintained with respect to the data about the participants at all times.

In another embodiment as shown in FIG. 4, a method for providing athletic, post-injury training 401 and providing at least one upscale health quarters facility 402 is shown including the following steps in various order: preparing athletes for a rehabilitation program 403, evaluating the athlete's physical condition 404, evaluating the athlete's mental state by conducting one or more clinical tests 406, implementing one or more holistic health quarters treatment plans 407, and providing one or more hydro-pool therapy plans implemented by utilizing one or more of a group of treatment systems 408 consisting of an underwater treadmill, resistance therapy jets, and hydro massage, wherein the one or more hydro-pool therapy plans may variously include a method for underwater monitoring and adjustable floor and depth settings. In certain aspects, the underwater monitoring is provided wherein the monitoring analyzes one or more aspects of one or more holistic health quarters treatment plans and wherein the monitoring method analyzes the corresponding data collected from the one or more holistic health quarters treatment plans, and evaluates said results. In other various aspects, the one or more hydro-pool therapy plans may be monitored and implemented in a plurality of modes.

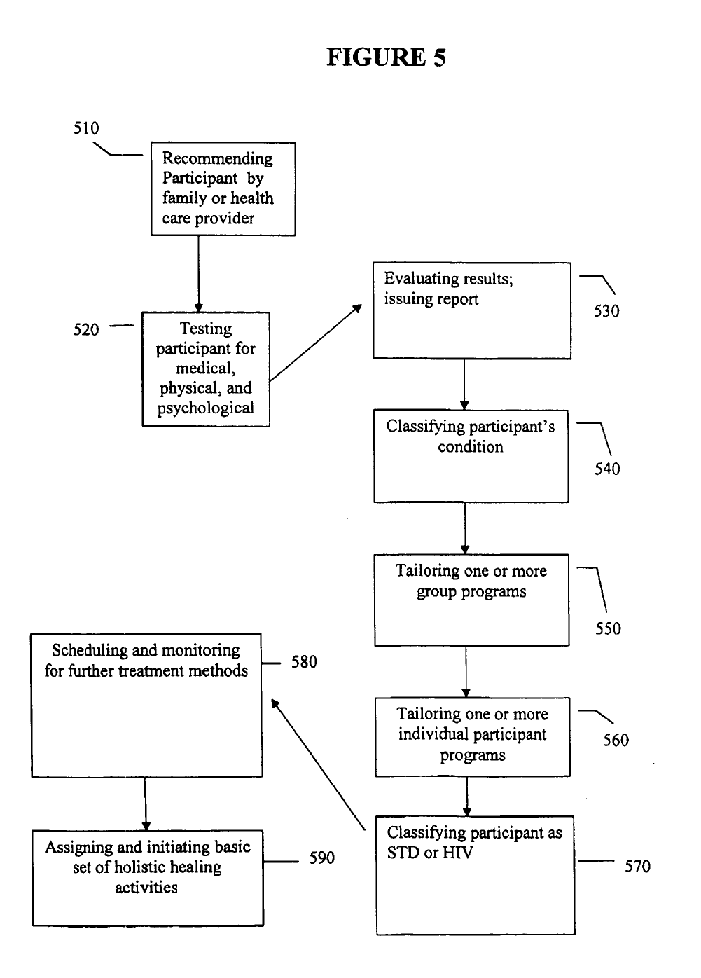

In another embodiment as shown in FIG. 5, a method for providing holistic health quarters systems includes recommending a participant by family or health care provider 510, testing a participant for medical, physical and psychological attributes 520, evaluating results and issuing reports 530, classifying a participants medical and rehabilitation condition 540, tailoring one or more group programs 550, tailoring one or more individual participant programs 560, classifying a participant as belonging to a class 570 selected from the group consisting of compromised or weakened immune systems, those in recovery, and those seeking overall body conditioning or enhancements, scheduling and monitoring a participant for further required treatment methods 580, and assigning and initiating a basic set of holistic healing services 590.

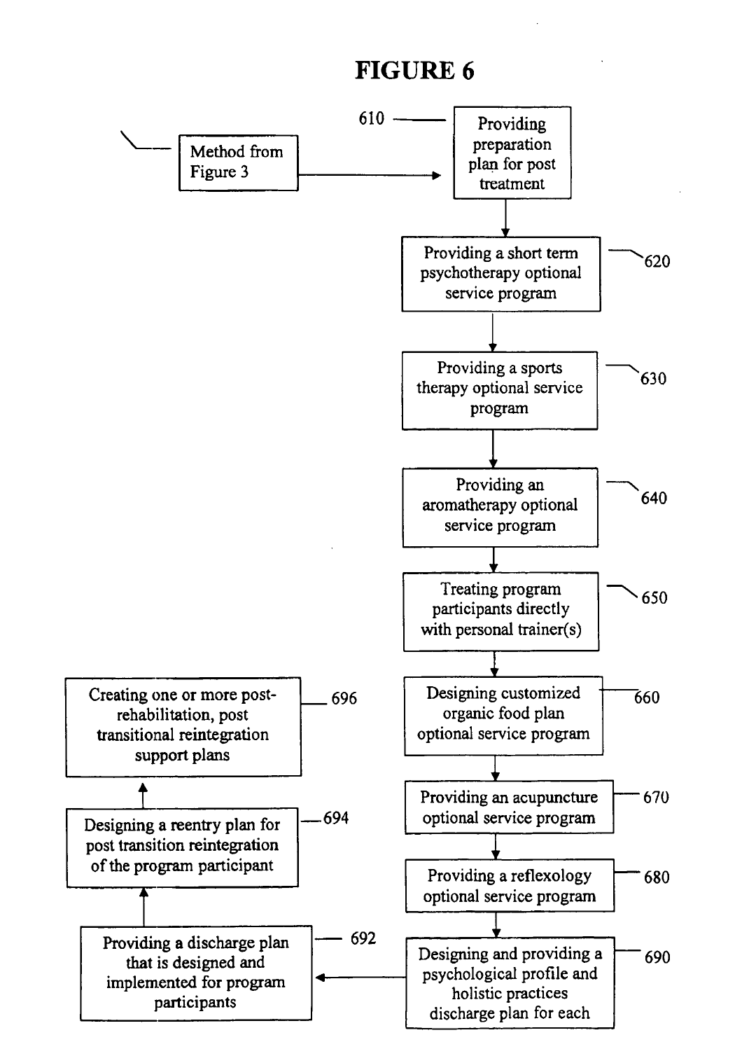

In another embodiment as shown in FIG. 6, a method for providing post rehabilitation and post transitional housing includes designing a reentry plan and providing a discharge plan. The method provides some or all of the steps from FIG. 3 and in some embodiments, further includes steps for providing preparation plans for post treatment 610, providing a short term psychotherapy optional service program 620, providing a sports therapy optional service program 630, providing an aromatherapy optional service program 640, treating program participants directly with personal trainers 650, designing customized organic food plan service programs 660, providing an acupuncture service program 670, providing a reflexology service program 680, designing and providing a psychological profile and at least one holistic practices practice discharge plan 690, creating one or more post-rehabilitation, post transitional reintegration support plans 696, designing a reentry plan for post transition reintegration of the program participant 694, and providing a discharge plan that is designed and implemented for program participants 692. One or more of the above mentioned steps may be in any order.

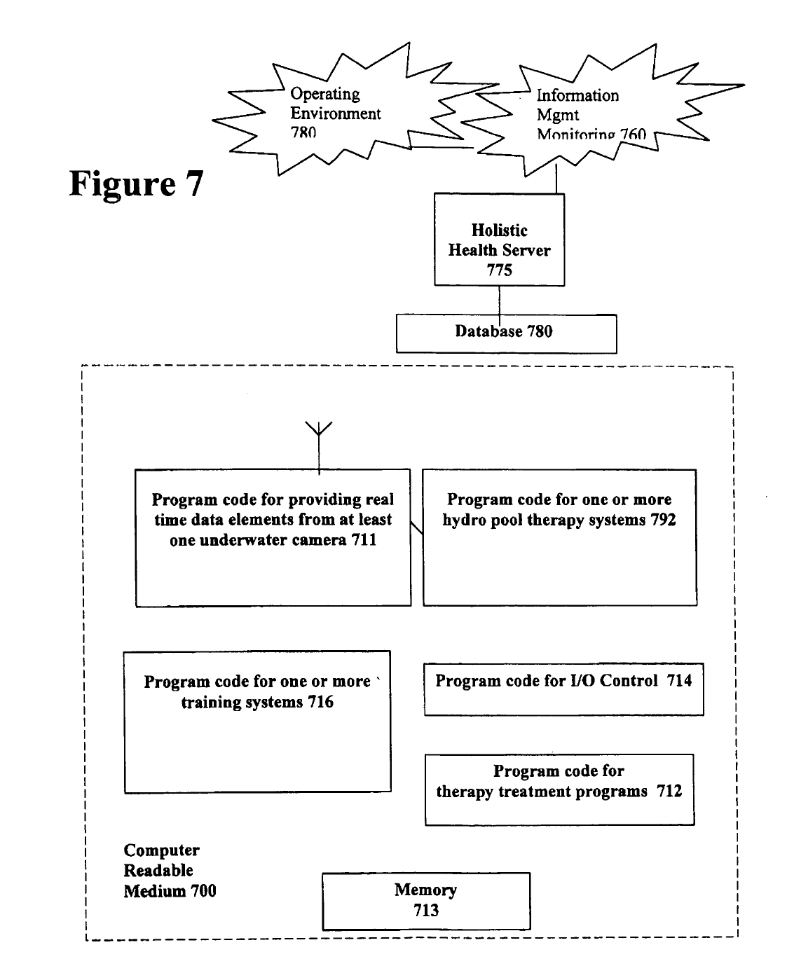

In another embodiment as shown in FIG. 7, a holistic health system includes a holistic health server 775, database repository 780, information monitoring management modules 760, one or more operating environments 780, and computer readable medium 700 that includes program code for: one or more external peripheral devices 711, one or more hydro therapy pool systems 792, input/output control modules 714, one or more memory modules 713, and one or more training systems 716.

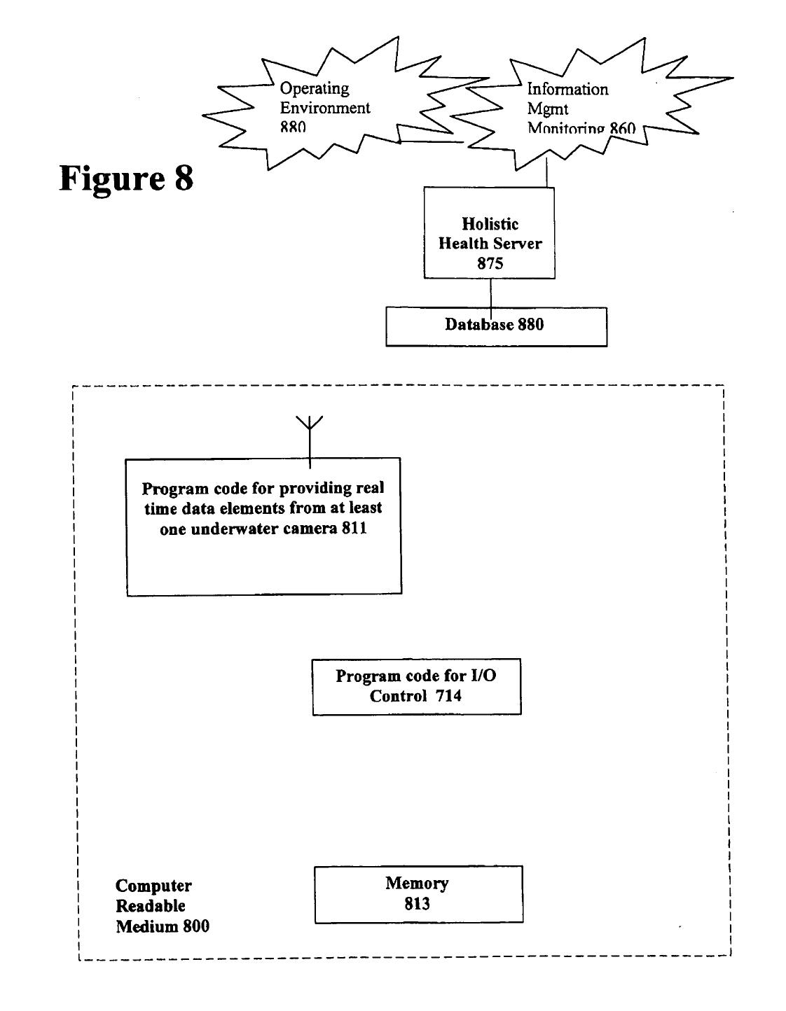

In another embodiment as shown in FIG. 8, a holistic health system includes a holistic health server 875, database repository 880, information monitoring management modules 860, one or more operating environments 880, and computer readable medium 800 that includes program code for: providing real time data elements from at least one underwater camera 811, input/output control modules 814, and one or more memory modules 813.

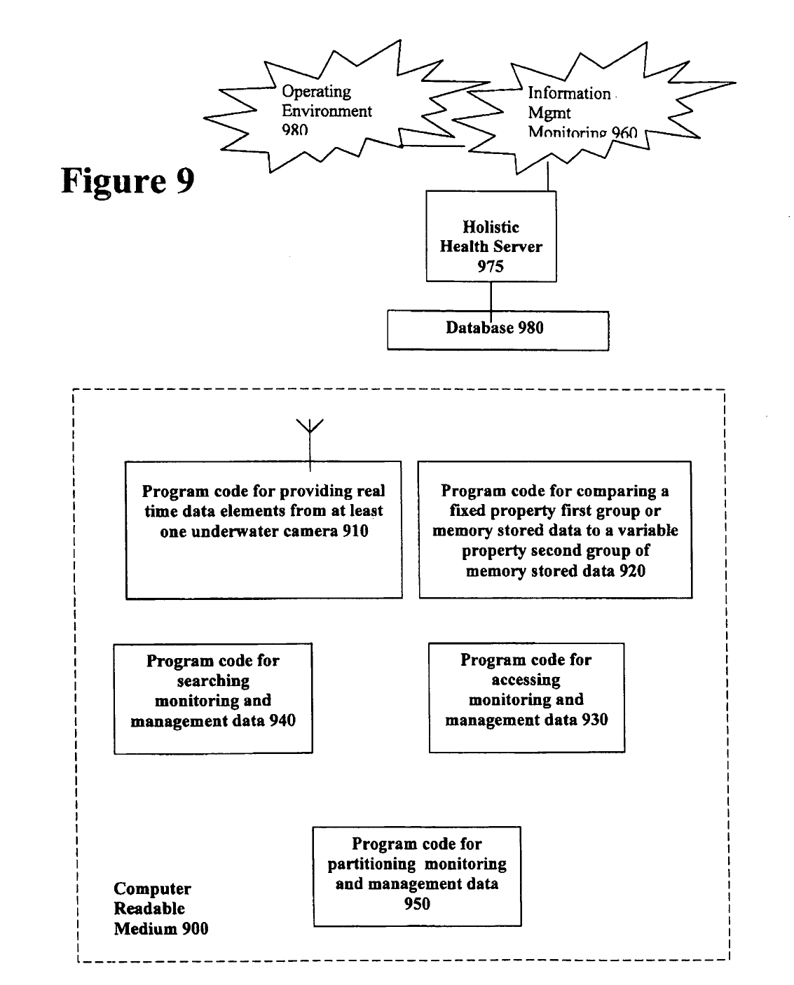

In another embodiment, as shown in FIG. 9, a holistic health system includes a holistic health server 975, database repository 980, information monitoring management modules 960, one or more operating environments 980, and computer readable medium 900 that includes program code for: providing real time data elements from at least one underwater camera 910, comparing a fixed property first group or memory stored data to a variable property second group of memory stored data 920, accessing monitoring and management data 930, partitioning monitoring and management data 950, searching monitoring and management data 940, and providing one or more training systems that utilize comparing data stored in a daily log of attributes 916. Other features of creating trained holistic health quarters transitional housing methods may be readily apparent to apply search algorithms to a fixed property group of collected data to a memory stored data repository 922 and a variable property second group of collected data to a statistically analyzed second group of memory stored data 924. In other certain aspects of the embodiment, an automated, secure electronics medical records information management systems automatically compares and partitions said first and second groups of data and is displayed to one or more program monitors to implement holistic health quarters transitional housing methods.

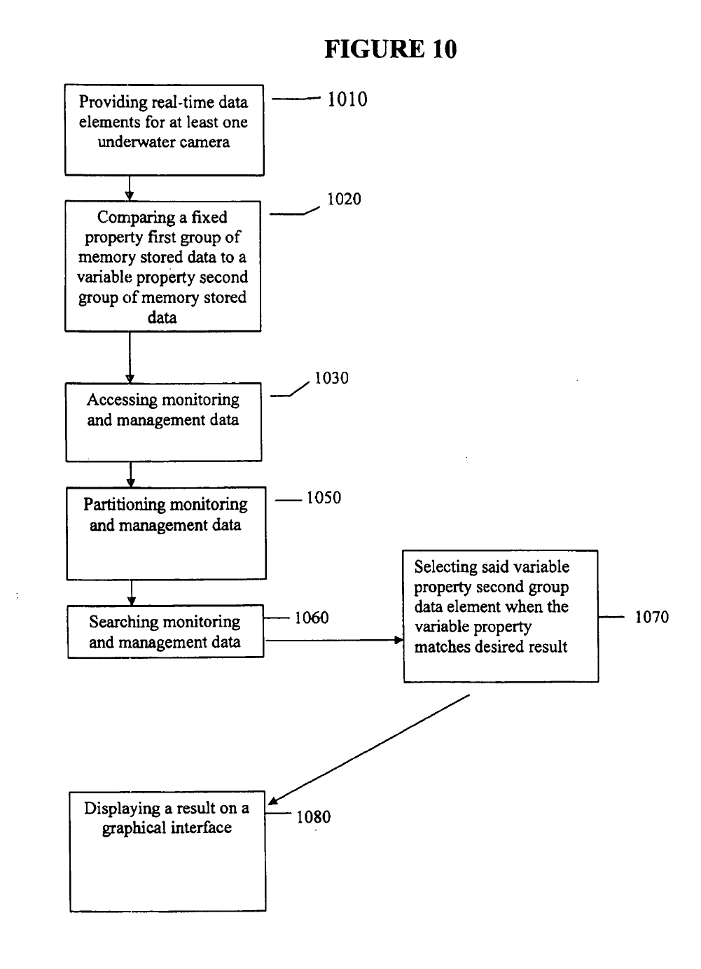

In another embodiment as shown in FIG. 10, a method for displaying, searching and partitioning monitoring and management data to implement holistic health quarters transitional housing methods includes the steps of providing real time data elements for at least one underwater camera 1010, comparing a fixed property first group of memory stored data to a variable property collected second group of memory stored data 1020, accessing monitoring and management data 1030, partitioning monitoring and management data 1050, searching monitoring and management data 1060, selecting said variable property second group data element when the variable property matches a desired result 1070, and displaying a result to a program monitor on a graphical interface 1080.

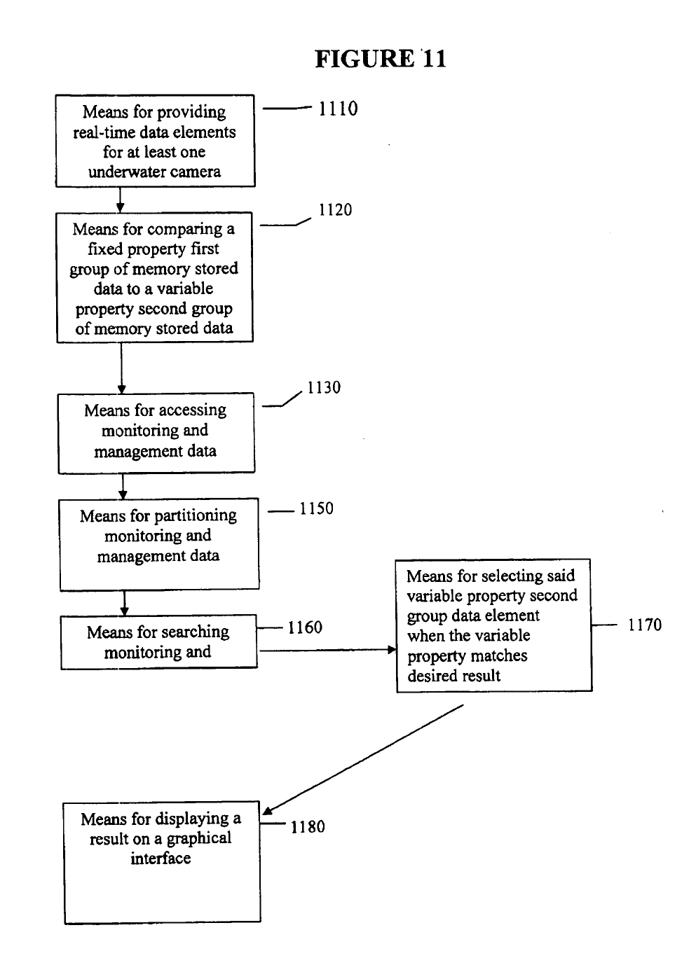

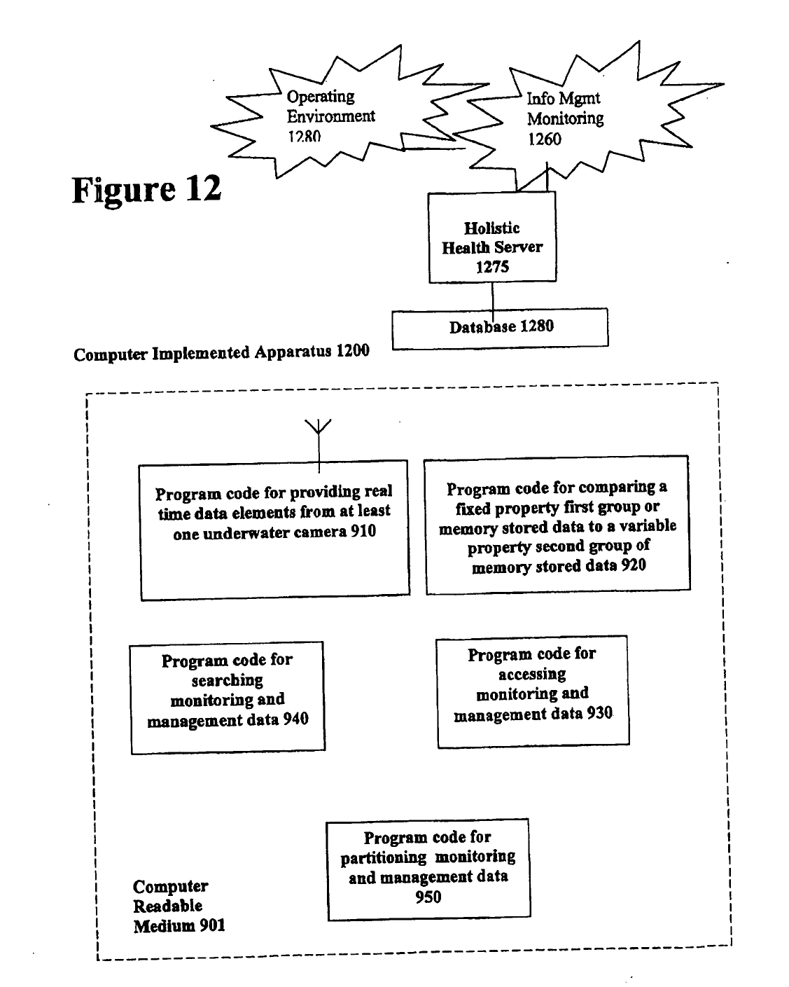

In another embodiment, FIG. 11 illustrates a method for providing means for providing real time data elements for accessing and monitoring holistic health quarters systems, including steps for providing means for real time data elements for at least one underwater camera 1110, means for comparing a fixed property first data group of memory stored data to a variable property second group of memory stored data 1120, means for accessing monitoring and management data 1130, means for partitioning monitoring and management data 1150, means for searching monitoring and management data 1160, means for selecting said variable property second group data element when the variable property matches the desired result to achieve a therapeutic outcome by a holistic health quarter program monitor 1170, and a means for displaying a result on a graphical interface 1180.

In other various aspects of the embodiment, the one or more hydro-pool therapy plans implemented by utilizing one or more of a group of treatment systems my include steps for providing underwater monitoring, providing participants the ability to view their response during a workout or rehabilitation session, and display user selected preferences in a subsequent workout. In other various aspects, the method may further include steps for providing underwater cameras that project the image on one or more flat screen monitors in various configurations throughout the pool. In certain aspects, a step for providing form and gain function monitoring is included.

In another embodiment, the method may variously include steps for providing access for wheel chair patients, training, and adjusting a moveable floor system to accommodate users of various height and weight.

In another embodiment, the method may include post-integration and reintegration support providing an upscale health quarters facility wherein post operative, athletic training, an mental health services are implemented to improve overall body conditioning and treating those with compromised or weakened immune systems; arranging one or more-hydro-therapy pool devices are provided wherein spa based therapies included advanced technology monitoring to produce accelerated recoveries; and designing and implementing one or more transitional treatment programs for one or more participant classifications wherein a program includes therapeutic treatment methods and holistic health care methods to enhance efficiency and intensity in participant programs for individuals on one or more levels of recovery and participants with compromised or weakened immune systems.

In another embodiment, holistic quarter services are provided utilizing a computer implemented apparatus and system of data analysis to perform the steps outlined above. In another embodiment, a computer readable medium provides program code for implementing a computer implemented apparatus and system for providing holistic health server, database, and information monitoring management operating environment. In another embodiment, a relational database tracks and monitors each condition, classification and results report. In yet another embodiment, at least one search algorithm provides an enterprise query for a secure, holistic quarters transitional housing program methods and systems.

In other embodiments, program code for implementing one or more of the method steps of holistic quarter services may be provided and included in various forms of computer readable media utilizing a computer implemented rehabilitation transitional housing healthcare management system. In certain aspects, the computer readable media may receive data from one or more external peripheral device that is specially designed in concert with one or more hydro-pool therapy treatment programs and one or more upscale, holistic health post operative or athletic training plan. In other various aspects, the computer system may comprise a bus; a memory unit coupled with said bus; and a processor coupled with said bus, said processor for executing a method for analyzing data comprising method steps for implementing holistic health quarters services, rehabilitation services, and upscale holistic health services transitional housing. In other embodiments, data may be sent and received from one or more hydro pool therapy systems or one or more post operative rehabilitation, training systems. In other embodiments, a trained system comprising of one or more algorithms utilize comparing data stored in a daily log of attributions. An exemplary operating environment is described in more detail below.

### Exemplary Operating Environments, Components, and Technology

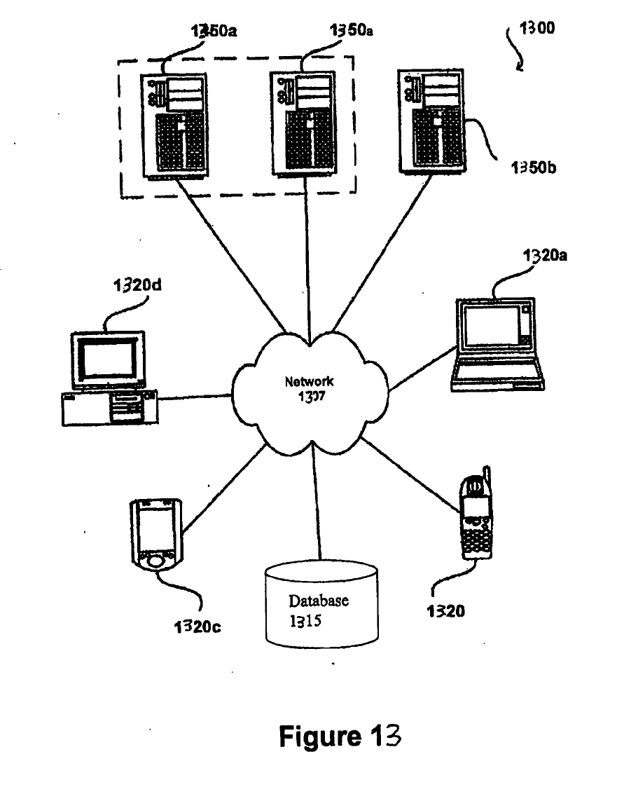

FIG. 13 is a block diagram illustrating components of an exemplary operating environment in which embodiments of the present invention may be implemented. The system 1100 can include one or more user computers, computing devices, or processing devices 1112, 1114, 1116, 1118, which can be used to operate a client, such as a dedicated application, web browser, etc. The user computers 1112, 1114, 1116, 1118 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 1112, 1114, 1116, 1118, may also have any of a variety of applications, including one or more development systems, database client and/or server applications, and Web browser applications. Alternatively, the user computers 1112, 1114, 1116, 1118, may be any other electronic device, such as a thin-client computer, Internet-enabled gaming system, and/or personal messaging device, capable of communicating via a network (e.g., the network 1110 described below) and/or displaying and navigating Web pages or other types of electronic documents. Although the exemplary system 1100 is shown with four user computers, any number of user computers may be supported.

In most embodiments, the system 1100 includes some type of network 1110. The network can be any type of network familiar to those skilled in the art that can support data communications using any of a variety of commercially-available protocols, including without limitation TCP/IP, SNA, IPX, AppleTalk, and the like. Merely by way of example, the network 1110 can be a local area network (“LAN”), such as an Ethernet network, a Token-Ring network and/or the like; a wide-area network; a virtual network, including without limitations a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2OOO, WCDMA, the Bluetooth protocol known in the art, and/or any other wireless protocol); and/or any combination of these and/or other networks.

The system may also include one or more server computers 1102, 1104, 1106 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 1106) may be dedicated to running applications, such as a business application, a Web server, application server, etc. Such servers may be used to process requests from user computers 1112, 1114, 1116, and 1118. The applications can also include any number of applications for controlling access to resources of the servers 1102, 1104, 1106.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 1112, 1114, 1116, and 1118. As one example, a server may execute one or more Web applications. The Web application may be implemented as one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 1112, 1114, 1116, 1118.

the system 1100 may also include one or more databases 1120. The database(s) 1120 may reside in a variety of locations. By way of example, a database 1120 may reside on a storage medium local to (and/or resident in) one or more of the computers 1102, 1104, 1106, 1112, 1114, 1116, 1118. Alternatively, it may be remote from any or all of the computers 1102, 1104, 1106, 1112, 1114, 1116, 1118, and/or in communication (e.g., via the network 1110) with one or more of these. In a particular set of embodiments, the database 1120 may reside in a storage-area network (“SAN”) familiar to those skilled in the art. Similarly, any necessary files for performing the functions attributed to the computers 1102, 1104, 1106, 1112, 1114, 1116, 1118 may be stored locally on the respective computer and/or remotely, as appropriate. In one set of embodiments, the database 1120 may be a relational database, such as Oracle 10 g that is adapted to store, update, and retrieve data in response to SQL-formatted commands.

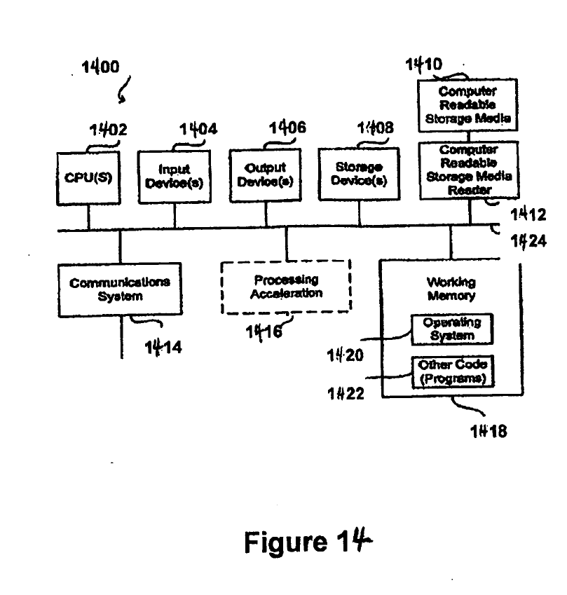

FIG. 14 illustrates an exemplary computer system 1200, in which embodiments of the present invention may be implemented. The system 1200 may be used to implement any of the computer systems described above. The computer system 1200 is shown comprising hardware elements that may be electrically coupled via a bus 1224. The hardware elements may include one or more central processing units (CPUs) 1202, one or more input devices 1204 (e.g., a mouse, a keyboard, etc.), and one or more output devices 1206 (e.g., a display device, a printer, etc.). The computer system 1200 may also include one or more storage devices 1208. By way of example, the storage device(s) 1208 can include devices such as disk drives, optical storage devices, solid-state storage device such as a random access memory (“RAM”) and/or a read-only memory (“ROM”), which can be programmable, flash-updateable and/or the like.

The computer system 1200 may additionally include a computer-readable storage media reader 1212, a communications system 1214 (e.g., a modem, a network card (wireless or wired), an infra-red communication device, etc.), and working memory 1218, which may include RAM and ROM devices as described above. In some embodiments, the computer system 1200 may also include a processing acceleration unit 1216, which can include a digital signal processor DSP, a special-purpose processor, and/or the like.

The computer-readable storage media reader 1212 can further be connected to a computer-readable storage medium 1210, together (and, optionally, in combination with storage device(s) 1208) comprehensively representing remote, local, fixed, and/or removable storage devices plus storage media for temporarily and/or more permanently containing, storing transmitting, and retrieving computer-readable information. The communications system 1214 may permit data to be exchanged with the network and/or any other computer described above with respect to the system 1200.

The computer system 1200 may also comprise software elements, shown as being currently located within a working memory 1218, including an operating system 1220 and/or other code 1222, such as an application program (which may be a client application, Web browser, mid-tier application, RDBMS, etc.). It should be appreciated that alternate embodiments of a computer system 1200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

One having skill in the art would appreciate that the heating pad 34 of the current embodiment may be replaced by other heaters including the earlier described heating element.

The above illustration provide many different embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims.

Accordingly, it is appropriate that the appended claims be constructed broadly and in a manner consistent with the scope of the invention, as set forth in the following claims.

What is claimed is:

1. A holistic health care, transitional housing system, comprising:
a referral of a prospective participant;
an upscale health quarters facility wherein post operative, athletic training, and mental health services are provided;
one or more hydro-therapy pool devices are provided wherein spa based therapies include advanced technology monitoring to produce accelerated recoveries;
One or more transitional treatment programs are designed and implemented for one or more participant classifications wherein a program includes therapeutic treatment methods and holistic health care methods;
One or more transitional care specialists analyze and profile one or more participants;
one or more program participants are profiled into one or more classifications;
an information management monitoring program collects and analyzes one or more program participant attributes;
one or more program participant's outcomes are determined from the one or more program participant attributes analyzed and collected by the information monitoring program;
a discharge plan is designed and implemented for one or more program participant outcomes wherein one or more of the program participant outcomes do not result in at least one subsequent transitional housing program plan and therapeutic treatment method.

2. The system of claim 1 wherein the information management monitoring program is implemented in a computing system and an operating environment.

3. The system of claim 1 wherein the hydrotherapy pools include one or more therapeutic Devices selected from a group consisting of one or more variable speed underwater treadmills, one or more resistance therapy jet pools, one or more hydro massage hose devices, one or more underwater monitoring systems, and one or more adjustable height pools.

4. The system of claim 3 wherein the one or more therapeutic devices include at least one underwater camera and wherein the at least one underwater camera provides real time data to the information management monitoring system.

5. The system of claim 1, further comprising;
a preparation plan for post treatment healing plans for self-implementation by the program participant;
a short term psychotherapy optional service program;
a sports therapy optional service program;
an aromatherapy optional service program;
one or more certified personal trainers;
one or more customized organic food plan optional services program;
an acupuncture optional service program;
a reflexology optional service program;
a psychological profile sand holistic practices discharge plan for each program participant;
a reentry plan for post transition reintegration of the program participant; and
one or more post-rehabilitation, post transitional reintegration support plans,

6. The system of claim 1, further comprising:
Said upscale holistic health quarter facility including one or more Private one-bedroom suites;
a wireless Internet service throughout said facility;
an LCD/DVD/Stereo in every suite;
a personal maid, housekeeper service;
24/7 staff availability service program;
one or more entertainment systems for each program participants use;
at least one sports medicine physician on-call;
one or more sauna and steam rooms;
a car available for program participants;
a theatre;
an in-house chef; and
one or more meeting rooms.

7. A method for providing athletic, post-injury training in an upscale, holistic transitional housing facility, including the following steps in various orders:
preparing athletes for a rehabilitation program, evaluating the athlete's physical condition, evaluating the athlete's mental state by conducting one or more clinical test, implementation one or more holistic health quarters treatment plans, providing one or more hydro-pool therapy plans implemented by utilizing one or more of a group of treatment systems consisting of an underwater treadmill, resistance therapy jets, and hydro massage, wherein the one or more hydro-pool therapy plans may variously include a method for underwater monitoring and adjustable floor and depth settings.

8. A method of providing holistic health quarters, transitional housing, comprising the following steps in any order:
providing a referral of a prospective participant;
providing an upscale health quarters facility wherein post operative, athletic training, and mental health services are implemented to improve overall body conditioning and treating those with compromised or weakened immune systems;
arranging one or more hydro-therapy pool devices are provided wherein spa based therapies include advanced technology monitoring to produce accelerated recoveries;
designing and implementing one or more transitional treatment programs for one or more participant classifications wherein a program includes therapeutic treatment methods and holistic health care methods to enhance efficiency and intensity in participant programs for individuals on one or more levels of recovery and participants with compromised or weakened immune systems;
assigning one or more transitional care specialist to analyze and profile one or more participants;
creating a profile for one or more program participants into one or more classifications;
providing an information management monitoring program that collects and analyzes one or more program participant attributes;
determining one or more program participant outcomes from the one or more program participant attributes analyzed and collected by the information monitoring program;
providing a discharge plan that is designed and implemented for one or more program participant outcomes wherein said program participant outcome does not result in at least one subsequent transitional housing program plan and therapeutic treatment method.

9. The method of claim 8 wherein the one or more therapeutic devices are selected from a group consisting of one or more variable speed underwater treadmills, one or more resistance therapy jet pools, one or more hydro massage hose devices, one or more underwater monitoring systems, and one or more adjustable height pools.

10. The method of claim 9 wherein the one or more therapeutic devices include at least one underwater camera and wherein the at least one underwater camera provides real time data to the information management monitoring system.

11. The method of claim 8, further comprising;
providing a preparation plan for post treatment healing plans for self-implementation by the program participant;
offering a short term psychotherapy optional service program;
providing a sports therapy optional service program;
providing an aromatherapy optional service program;
directly treating one or more program participants with one or more certified personal trainers;
designing one or more customized organic food plan optional service program;
providing and acupuncture optional service program;
providing a reflexology optional service program;
designing and providing a psychological profile and holistic practices discharge plan for each program participant;
designing a reentry plan for post transition reintegration of the program participant; and
creating one or more post-rehabilitation, post transitional reintegration support plans.

12. A holistic health care, transitional housing system, comprising;
means for a referral of a prospective participant;
means for an upscale health quarters facility wherein post operative, athletic training and mental health services are provided;
means for one or more hydro-therapy pool devices are provided wherein spa based therapies include advanced technology monitoring to produce accelerated recoveries;
means for one or more transitional treatment programs are designed and implemented for one or more participant classifications wherein a program includes therapeutic treatment methods and holistic health care methods;
means for one or more transitional care specialists analyze and profile one or more participants;
means for one or more program participants are profiled into one or more classifications;
means for providing an information management monitoring program collects and analyzes one or more program participant attributes;
means for one or more program participant outcomes are determined from the one or more program participant attributes analyzed and collected by the information monitoring program;
means for a discharge plan is designed and implemented for one or more program participant outcomes wherein said program participant outcome does not result in at least one subsequent transitional housing program plan and therapeutic treatment method.

13. A computer system for providing holistic health quarter, transitional housing services, comprising a bus; a memory unit coupled with said bus; a processor coupled with said bus, said processor for executing a method for providing methods and products for holistic health quarters and transitional housing analyzing monitoring and management data comprising;
accessing said monitoring and management data further comprising a first group and a second group of memory stored monitoring and management data strings;
partitioning a portion of said monitoring and management data into said first group of memory stored monitoring and management data strings, said partitioning into said first group based on a fixed byte-width property of said monitoring and management data strings;
partitioning a portion of said monitoring and management data into said second group of memory stored monitoring and management data strings, said partitioning into said second group based on a variable byte-width property of said monitoring and management data strings;
searching through said first group of monitoring and management data strings for a prescribed string utilizing a fixed byte-width monitoring and management data string process;
searching through said second group of monitoring and management data strings for a prescribed string utilizing a variable byte-width monitoring and management data string process, wherein the execution of said fixed byte-width monitoring and management data string process is more efficient than the execution of said variable byte-width monitoring and management data string process to implement various steps to implement holistic quarter services that may be provided and included in various forms of computer readable media utilizing a computer implemented rehabilitation transitional housing healthcare management system;
providing computer readable media to receive data from one or more external peripheral devices that are specially designed to be coupled with one or more hydro-pool therapy treatment programs and one or more upscale, holistic health post operative or athletic training plans; providing a referral of a prospective participant;
providing an upscale health quarters facility wherein post operative, athletic training, and mental health services are implemented;
arranging one or more hydro-therapy pool devices are provided wherein spa based therapies include advanced technology monitoring to produce accelerated recoveries;
designing and implementing one or more transitional treatment programs for one or more participant classifications wherein a program includes therapeutic treatment methods and holistic health care methods;
assigning one or more transitional care specialists to analyze and profile one or more participants;
creating a profile for one or more program participants into one or classifications;
providing an information management monitoring program that collects and analyzes one or more program participant attributes;
determining one or more program participant outcomes from the one or more program participant attributes analyzed and collected by the information monitoring program; and
providing a discharge plan that is designed and implemented for one or more program participant outcomes wherein said program participant outcome does not result in at least one subsequent transitional housing program plan and therapeutic treatment method.

14. The system of claim 1 wherein one or more of the upscale health quarters facilities provide one or more transitional treatment programs for one or more program participant classifications and apply rehabilitative therapies that allow a patient or athlete to cleanse themselves by conditioning the mind and spirit or to implement custom dietary programs that utilize holistic supplements, mental and spiritual cleansing by utilizing holistic treatment methods.

15. The system of claim 2 wherein the computing system and operating environment to implement the information management monitoring systems utilize one or more special purpose peripheral devices to provide input output functionality to the at least one underwater camera or underwater optical scanner or eye monitor.

16. A method for providing athletic, post-injury training in an upscale, holistic transitional housing facility, including the following steps in various orders:
preparing athletes for a rehabilitation program, evaluating the athlete's physical condition, evaluating the athlete's mental state by conducting one or more clinical tests, implementing one or more holistic health quarters treatment plans, providing one or more hydro-pool therapy plans implemented by utilizing one or more of a group of treatment systems consisting of an underwater treadmill, resistance therapy jets, and hydro massage, wherein the one or more hydro-pool therapy plans may variously include a method for underwater monitoring and adjustable floor and depth settings and wherein the computing system and operating environment to implement the information management monitoring systems utilizes one or more special purpose peripheral devices to provide input output functionality to the at least one underwater camera or underwater optical scanner or eye monitor.

17. The method of claim 4 further comprising the following steps in any order:
receiving a first signal from the one or more special purpose peripheral devices;
processing said first signal in a monitoring system execution module;
calculating one or more program participant attributes;
analyzing said one or more program attributes to determine one or more program participant outcomes;
presenting said results in a therapeutic results chart; and mapping said therapeutic results chart to one or more associated discharge plans.

18. The method of claim 5 wherein the post-rehabilitation, post transitional reintegration support plans is associated with one or more therapeutic results and discharge plans.

19. The method of claim 6 wherein the upscale holistic health quarter facility further comprises:
providing said therapeutic results chart related to one or more associated discharge plan and maintaining strict confidentiality with respect to the data associated with the participants at all times;
providing one or more security encryption routines associated with the one or more therapeutic results to one or more program participants and stored in one or more database repositories associated with the information monitoring computing system and operating environment; and associating said post-rehabilitation, post transitional reintegration support plans when one or more discharge plans is associated with one or more program participant outcomes that does not include at least one subsequent transitional housing program plan or on-site therapeutic treatment step.

20. The method of claim 7 wherein the one or more therapeutic devices include at least one underwater camera and wherein the at least one underwater camera provides real time data to the information management monitoring system.
